(19) United States
(12) Patent Application Publication
(10) Pub. No.: US 2009/0038572 A1
(43) Pub. Date: Feb. 12, 2009

(54) Cam actuated roller assembly and clad roller pin for same

(75) Inventors: Edwin H. Langewisch, Dunlap, IL (US); Arthur S. Lindell, Morton, IL (US)

Correspondence Address: CATERPILLAR c/o LIELL, MCNEIL & HARPER, P.O. BOX 2417, 511 SOUTH MADISON STREET, BLOOMINGTON, IN, 47402-2417, US

(73) Assignee: Caterpillar Inc.

(21) Appl. No.: 11/891,177

(22) Filed: Aug. 9, 2007

(51) Int. Cl. F01L 1/18; B21D 53/84; F16H 53/00; B21K 1/02

(52) U.S. Cl. 123/90.44; 29/888.2; 74/567

(57) ABSTRACT

Cam actuated systems, such as valve trains for an engine, typically bring cam lobe action to the engine valve via a linkage that includes a cam actuated roller assembly which may be either a rocker or a lifter. These cam actuated rocker assemblies include a housing with a pair of arms with roller support bores there through. A roller support pin is received in the roller support bores, and rotationally supports a roller mounted about the roller pin and between the arms of the housing. The roller pin may include a relatively hard and inexpensive core, such as steel, cladded with a relatively soft more expensive metal, such as bronze.

### TECHNICAL FIELD

The present disclosure relates generally to cam actuated roller assemblies, and more particularly to a roller pin with a core of a first metallic material surrounded a cladding of a second metallic material.

### BACKGROUND

Bronze roller pins are commonly used in valve and injector rockers and lifter components of mid range and heavy duty engines. The roller pins serve as axles and rotationally support a roller that follows a cam to actuate valves or injectors to open and shut in a manner commonly known to those skilled in the art. Bronze is a preferred material for these roller pins due to its softness or malleability. If a particle of debris, such as those suspended in lubrication oil, were to become trapped between the roller pin and a roller, the bronze could deform enough to embed the particle and reduce galling and other wear that the particle could cause on the housing or roller due to friction as the roller rotates about the roller pin.

A major drawback of bronze pins is that bronze is substantially more expensive than typical engine construction material, such as steel. Cheaper stainless steel is sometimes utilized even though it is a less than desirable material for a roller pin, because it is much harder than bronze and could increase the galling and other wear and tear on a roller pin, its housing and the roller if a particle of debris found its way between the roller pin and either the housing or roller. This typically leaves an engine manufacturer with a choice between cheaper stainless steel pins with increased wear and tear, or more expensive bronze pins, which decrease wear but may be as much as ten times or more expensive than steel.

Bronze encompasses a broad array of copper alloys with other metals or elements, including tin, aluminum, silicon, nickel and others. Those skilled in the art have come to recognize that a subset of bronze copper alloys known as phosphor bronzes generally work best in roller pin applications for cam actuated roller assemblies. However, researchers are constantly seeking new and better alloys to extend life and enhance performance in the ongoing and evolving environment associated with internal combustion engines. For instance, U.S. Pat. No. 6,210,503 identifies a specific subset of bronze alloys that supposedly outperform previously known bronze alloys in cam actuated roller assembly applications. In particular, this reference teaches a leaded manganese silicon bronze alloy that supposedly outperforms other alloys in a certain class of engines utilizing state of the art lubricant additives and the like. Although these more exotic bronze alloys may incrementally outperform other known bronze alloys, they may or may not be justified based upon the ever increasing costs they bring to engine manufacturing.

The present disclosure is directed to one or more of the problems set forth above.

### SUMMARY OF THE DISCLOSURE

A cam actuated roller assembly includes a housing that defines a shaft bore and includes a pair of spaced arms that each define a roller support bore. A roller pin extends between the arms and is received in each of the roller support bores. A roller is mounted for rotation about the roller pin and is positioned between the arms. The roller pin has a core of a first metallic material surrounded by a cladding of a second metallic material that is different from the first metallic material. In one specific aspect, the roller pin has a core of steel and a cladding of bronze.

In another aspect, a cam actuated roller assembly may be made by forming a roller pin by cladding a relatively hard metallic core with a relatively soft metal. A roller is positioned around the roller pin between a pair of arms of a housing. The roller pin is press fitted in a pair of roller support bores that extend through the arms of the housing.

### BRIEF DESCRIPTION OF THE DRAWINGS

FIG. 1 is a side view of a valve train according to one aspect of the present disclosure;

FIG. 2 is an exploded perspective view of a cam actuated roller assembly according to another aspect of the present disclosure; and

FIG. 3 is a partially sectioned side view of a roller pin according to still another aspect of the present disclosure.

### DETAILED DESCRIPTION

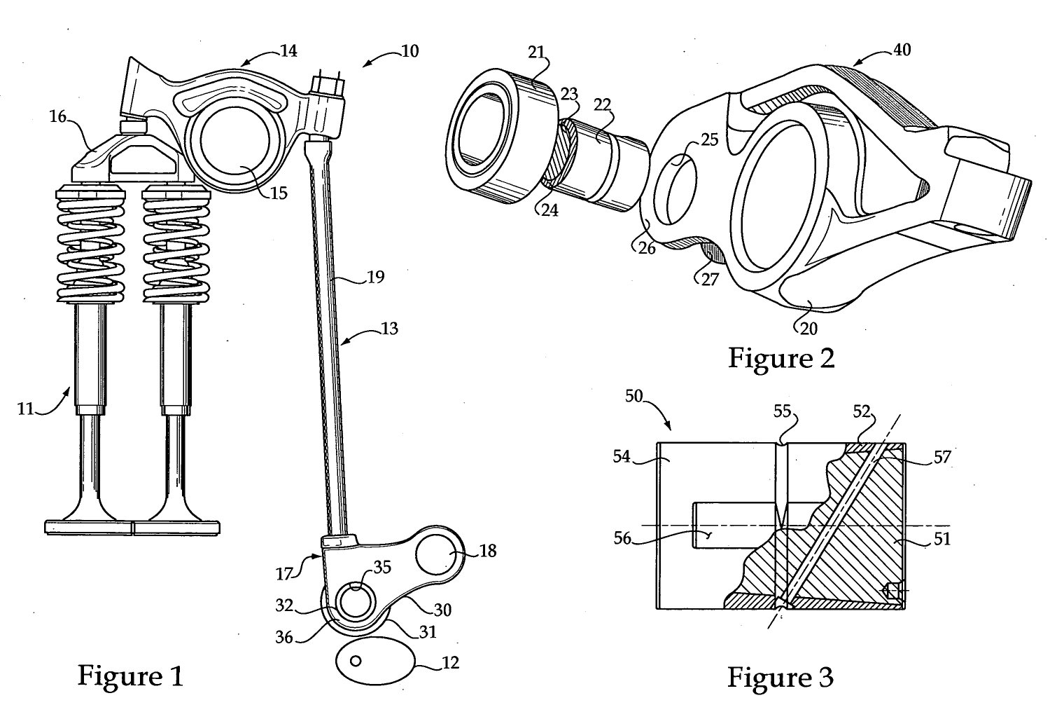

Referring to FIG. 1, a valve train 10 for an internal combustion engine is utilized to illustrate one aspect of the present disclosure. In particular, valve train 10 includes a pair of valves 11 that are moved between open and closed positions via rotation of a cam 12. Cam actuation is carried to valves 11 via a linkage 13 that includes a lifter 17, a rod 19, a rocker 14 and a bridge 16. As cam 12 rotates, lifter 17 is rotated about a shaft 18 to lift rod 19. This motion in turn causes rocker 14 to pivot about shaft 15 to move valves 11, which are coupled to rocker 14 via bridge 16 on the opposite side from rod 19 in a conventional manner.

Lifter 17 includes a housing 30, which may be made of any suitable material, such as a machined casting, to include a pair of arms 36 that each define a roller support bore 35. Housing 30 defines a shaft bore for receiving a shaft 18, about which housing 30 rotates. A roller 31 is positioned between arms 36 and is supported by a roller pin 32 that is received (press fit) in the roller support bores 35 of each arm 36 in a conventional manner. The roller may be made from machined and hardened steel as well as the cam 12 in a conventional manner. Thus, as cam 12 rotates, roller 31 rotates about roller pin 32 to transfer the rotational motion of cam 12 into the translational motion of the linkage 13.

Although roller pin 32 has much the same appearance as conventional bronze roller pins, it has a structure that renders it substantially less expensive without sacrificing performance. In particular, roller pin 32 includes a relatively thin bronze cladding, maybe on the order of about two millimeters, on a relatively inexpensive steel core. Thus, only the amount of bronze necessary to create a robust cladding and permit machining of various surface features (e.g., grooves, flats, etc.) may be necessary. This will render an outer cylindrical surface suitable for incorporation of occasional particulate matter that may find its way onto a surface without undermining the rotational action of roller 31. Those skilled in the art will appreciate that many suitable bronze alloys are known for application in roller pins as illustrated. These bronze alloys are typically selected for a desired combination of wear resistance, corrosion resistance, low friction and the ability to embed hard debris and other oil contaminants without scuffing or galling in order to substantially improve cam and/or linkage life. Those skilled in the art will appreciate that wear, especially unsymmetrical wear of the roller pin 32 can adversely effect the rotational stability of the roller 31. This in turn can undermine the cam 12 to roller 31 interface by undermining the freedom of rotation and load distribution, which can eventually shorten the life span of the linkage 13 components and/or cam 12.

Referring now to FIG. 2, a rocker 40 according to another aspect of the present disclosure includes a housing 20 with a pair of arms 26 and 27 that each define a roller pin support bore 25. A roller pin 22 is received in the roller pin support bores 25 and extends across the gap between arms 26 and 27. A roller 21 is mounted for rotation about roller pin 22 and is positioned between arms 26 and 27 in a conventional manner. Pin 22 appears substantially similar to bronze pins utilized in the art. However, roller pin 22 comprises a steel core 23 with bronze cladding 24. Those skilled in the art will appreciate that the bronze cladding 24 need only extend around the cylindrical surface and not the ends of the steel core 23.

Referring to FIG. 3, a partially sectioned side view of a roller pin 50 is illustrated to show one example embodiment. In particular, a conically shaped steel core 51 is received and bonded in a conically shaped bore defined by bronze cladding 52. This composite piece may then be machined to include lubrication enhancing features such as groove 55 and a lubricant passageway 57. The outer bronze cladding 52 may also be machined to include one or more flats 56 that also help facilitate penetration of lubricating oil between the outer surface 54 of roller pin 50 and the inner surface of the roller (see rollers 31 and 21 in FIGS. 1 and 2, respectively). Thus, it is generally desirable for the roller to ride on a thin film of lubricating oil between the outer surface of the roller pin and the inner surface of the roller. The relatively soft bronze material helps to facilitate this action even when small particles suspended in the lubrication oil become embedded into the soft bronze surface during normal engine operation.

### INDUSTRIAL APPLICABILITY

The present disclosure finds potential application in any cam actuated roller assembly, such as those used for engine valve train actuation, for fuel injector actuation, to actuate unit pumps and even to move plungers associated with common rail fuel pumps. However, the present disclosure even has potential application outside of those typically associated with engines. For instance, the present disclosure could find potential application in any cam actuated roller assembly, such as those that might be used for example, in conjunction with a screw machine. Those skilled in the art will appreciate that it is desirable, especially in engine applications, to use a bronze surfaced roller pin to support a relatively hard, maybe steel, roller for following rotation of a cam 12. (See FIG. 1) Depending on how the pin is manufactured, it may consist only of a steel core with bronze cladding. Other manufacturing strategies may include traces of other materials, such as agents to promote bonding of the cladding to the core. Bronze has often been the choice material due to its relatively soft malleability, corrosion resistance and wear resistance. However, bronze is substantially more expensive than other materials typically used in engine applications, such as a variety of steel alloys. The present disclosure thus retains the advantages brought by the bronze rotational bearing surface, without the relatively high costs associated with a solid bronze roller pin.

Although the present disclosure has been illustrated specifically in the case of a roller pin 50 comprising a steel core 51 with bronze cladding 52, the present disclosure should not be so limited. In a broader sense, the roller pin 50 may include a core of a first metallic material surrounded by cladding of a second metallic material that is different from the first metallic material. The first metallic material comprising the core would typically utilize a relatively harder and less expensive material, such as any suitable steel alloy. The second metallic material may include a relatively soft and likely more expensive metallic material, such as any of a variety of copper based alloys commonly referred to as bronze. For instance, a variety of leaded bronze alloys may be suitable for components according to the present disclosure. However, other metallic alloys that may not even be copper based are also contemplated.

A cladded roller pin 50 of the present disclosure may be made using any suitable cladding strategy. For instance, one may start with a conically shaped steel core that is received in a conically shaped bore of bronze cladding having an average radial thickness may be on the order of about two millimeters. The term “about” means that when the number is rounded to one significant digit, the numbers are equal (e.g. 2.4 can be said to be about 2). The joining process may occur with the steel core at a relatively low temperature and a bronze cladding at a relatively high temperature to facilitate a shrink press fit. This press fit may then be enhanced through some bonding process, such as sintering. Alternatively, relatively long steel rods could be cladded using conventional techniques and then the rod could be cut to lengths associated with a desired roller pin length. The resultant blank may then be machined to include the internal and external surface features (e.g., passageway(s), groove(s) and flat(s)) of the roller pin required for a specific application, such as in a lifter 17 (FIG. 1) or a rocker 40 (FIG. 2)).

After correctly machining roller pin 32, 22, the cam following roller assembly e.g., lifter 17, (FIG. 1) or rocker 40, (FIG. 2) may be assembled in a conventional manner. For instance, the housing 20 may be brought up to a relatively higher temperature whereas the roller pin 22 may be frozen or otherwise brought to a relatively low temperature in order to provide a slight radial clearance between the outer surface of roller pin 22 and the inner surface of roller support bores 25 to facilitate a shrink press fit. The roller 21 or 31 is then positioned between the arms 26 and 27 and the roller pin 22, 32 is then inserted through the roller support bores and through the internal bore of roller 21 to extend between the two arms. As the temperatures of the roller pin 22 and the housing 20 merge, a relatively tight fit is created between the roller support pin 22 such that it does not rotate in the roller support bores 25.

The present disclosure has the advantage of providing the wear resistance and ability to embed particulate matter associated with relatively more expensive bronze roller pins of the prior art, but does so at a fraction of the cost. By employing bronze cladded steel pins in an engine, it is believed that costs can be reduced maybe on the order of $20.00 or more per engine without sacrificing performance. However, the present disclosure recognizes that the industry is constantly seeking new alloys with the best desirable combination of wear resistance, corrosion resistance and the ability to embed particulate matter. Thus, any of these currently known or to be discovered alloys are suitable for use in cam actuated roller assemblies of the present disclosure using conventional cladding techniques on a relatively inexpensive steel core pin.

It should be understood that the above description is intended for illustrative purposes only, and is not intended to limit the scope of the present invention in any way. Thus, those skilled in the art will appreciate that other aspects of the invention can be obtained from a study of the drawings, the disclosure and the appended claims.

What is claimed is:

1. A cam actuated roller assembly comprising:
a housing defining a shaft bore and including a pair of spaced arms that each define a roller support bore;
a roller pin extending between the arms and received in each of the roller support bores;
a roller mounted for rotation about the roller pin and positioned between the arms; and
the roller pin having a core of a first metallic material surrounded by a cladding of a second metallic material that is different from the first metallic material.

2. The cam actuated roller assembly of claim 1 wherein the core has a conical outer surface received in a conically shaped bore defined by the cladding.

3. The cam actuated roller assembly of claim 2 wherein the first metallic material includes steel; and
the second metallic material includes bronze.

4. The cam actuated roller assembly of claim 3 wherein the roller pin consists of a steel core with bronze cladding.

5. The cam actuated roller assembly of claim 1 wherein the first metallic material includes steel; and
the second metallic material includes bronze.

6. The cam actuated roller assembly of claim 5 wherein the roller pin consists of a steel core with bronze cladding.

7. The cam actuated roller assembly of claim 1 wherein the housing is a rocker.

8. The cam actuated roller assembly of claim 1 wherein the housing is a lifter.

9. The cam actuated roller assembly of claim 1 wherein the cladding has a thickness of about two millimeters.

10. The cam actuated roller assembly of claim 5 wherein the roller pin consists of a steel core with bronze cladding.

11. A roller pin comprising:
a core of a first metallic material surrounded by a cladding of a second metallic material that is different from the first metallic material;
the first metallic material includes steel; and
the second metallic material includes bronze.

12. The roller pin of claim 11 consisting of a steel core with bronze cladding.

13. The roller pin of claim 12 wherein the core has a conical shape received in a conically shaped bore of the cladding.

14. The roller pin of claim 11 wherein the core has a conical shape received in a conically shaped bore of the cladding.

15. A method of making a cam actuated roller assembly, comprising the steps of:
forming a roller pin by cladding a relatively hard metallic core with a relatively soft metal;
positioning a roller around the roller pin and between a pair of arms of a housing; and
press fitting the roller pin in a pair of roller support bores through the arms of the housing.

16. The method of claim 15 wherein the forming step includes cladding a steel core with bronze.

17. The method of claim 15 including a step of forming the housing into a rocker.

18. The method of claim 15 including a step of forming the housing as a lifter.

19. The method of claim 15 wherein the forming step includes cladding a relatively large radius steel core with a thin radial layer of bronze.

20. The method of claim 19 including a step of machining surface features on an outer surface of the roller pin after the cladding step.
